(19) United States
(12) Patent Application Publication
(10) Pub. No.: US 2018/0124701 A1
(43) Pub. Date: May 3, 2018

(54) SCHEDULING REQUEST (SR) PERIOD EXTENSION FOR LOW POWER ENHANCEMENT IN A WIRELESS COMMUNICATION DEVICE

(71) Applicant: MEDIATEK INC., Hsin-Chu City (TW)

(72) Inventors: Ming-Fong JHANG, Zhubei City (TW); Jia-Shi Lin, Fangyuan Township (TW); Jen-Kuan Lin, Keelung City (TW)

(73) Assignee: MEDIATEK INC., Hsin-Chu City (TW)

(21) Appl. No.: 15/786,255

(22) Filed: Oct. 17, 2017

Related U.S. Application Data
(60) Provisional application No. 62/414,832, filed on Oct. 31, 2016.

(51) Int. Cl. H04W 52/02; H04W 76/04; H04W 72/12

(52) U.S. Cl. CPC H04W 52/0216; H04W 76/046; H04W 72/1289; H04W 76/048

(57) ABSTRACT

Aspects of the disclosure provide a method for reducing power consumption of a wireless communication device. The method can include receiving a discontinuous reception (DRX) configuration specifying a DRX having a DRX cycle, receiving an original scheduling request (SR) configuration specifying an original SR period, selecting an extended SR period according to the DRX cycle, the extended SR period being a multiple of the original SR period and corresponding to a set of candidate SR offsets, determining for each of the set of candidate SR offsets an overlap between active times caused by the DRX and active times caused by SR transmissions corresponding to the extended SR period, and selecting one of the set of the candidate SR offsets having a largest overlap to determine a period-extended SR configuration including the selected extended SR period and the selected SR offset.

### INCORPORATION BY REFERENCE

This present disclosure claims the benefit of U.S. Provisional Application No. 62/414,832, “Autonomous SR Period Extension for Low Power Enhancement” filed on Oct. 31, 2016, which is incorporated herein by reference in its entirety.

### TECHNICAL FIELD

The present disclosure relates to a low power enhancement technique in a wireless communication device. Specifically, the present disclosure describes a method for extending a period of uplink scheduling requests (SRs) such that interruptions to sleep times of discontinuous reception (DRX) caused by transmission of uplink SRs can be minimized. As a result, power consumption of the wireless communication device can be reduced.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

A mobile device configured with discontinuous reception (DRX) can periodically transition between an active state and a sleep state to save power while communicating with a base station. When an unexpected scheduling request for uplink resources is to be transmitted, the mobile device can prematurely switch to the active state from the sleep state, thus reducing power savings realized during the sleep state.

### SUMMARY

Aspects of the disclosure provide a method for reducing power consumption of a wireless communication device. The method can include receiving a discontinuous reception (DRX) configuration specifying a DRX having a DRX cycle, receiving an original scheduling request (SR) configuration specifying an original sequence of SR transmission opportunities having an original SR period, selecting an extended SR period corresponding to an extended sequence of SR transmission opportunities according to the DRX cycle, the extended SR period being a multiple of the original SR period and corresponding to a set of candidate SR offsets, determining for each of the set of candidate SR offsets an overlap between active times caused by the DRX and active times caused by SR transmissions at each of the extended sequence of SR transmission opportunities, and selecting one of the SR offsets having a largest overlap from the set of the candidate SR offsets to determine a period-extended SR configuration including the selected extended SR period and the selected SR offset.

In one example, the set of candidate SR offsets can include an original SR offset specified by the original SR configuration, and one or more SR offsets equal to the original SR offset plus one or more original SR periods. In another example, the extended SR period can be equal to or smaller than the DRX cycle of the DRX. In a further example, the extended SR period can be smaller than an uplink data transmission delay that an application in the wireless communication device can tolerant. In one example, the overlap between the active times caused by the DRX and the active times caused by SR transmissions can be calculated within a time period equal to a common multiple of the DRX cycle of the DRX and the selected extended SR period.

Embodiments of the method can further includes determining a period-extended SR configuration for each of multiple categories of applications in the wireless communication device, and transmitting an SR for an application according to a period-extended SR configuration corresponding to a category of applications including the application.

Aspects of the disclosure provide a wireless communication device. The device can include circuitry configured to receive a discontinuous reception (DRX) configuration specifying a DRX having a DRX cycle, receive an original scheduling request (SR) configuration specifying an original sequence of SR transmission opportunities having an original SR period, select an extended SR period corresponding to an extended sequence of SR transmission opportunities according to the DRX cycle, the extended SR period being a multiple of the original SR period and corresponding to a set of candidate SR offsets, determine for each of the set of candidate SR offsets an overlap between active times caused by the DRX and active times caused by SR transmissions at each of the extended sequence of SR transmission opportunities, and select one of the SR offsets having a largest overlap from the set of the candidate SR offsets to determine a period-extended SR configuration including the selected extended SR period and the selected SR offset.

Aspects of the disclosure provide a non-transitory computer readable medium storing program instructions that, when executed by a processor, cause the processor to perform the method for reducing power consumption of a wireless communication device.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a wireless communication network according to an embodiment of the disclosure;

FIG. 2 shows an example of a scheduling request (SR) period extension scheme according to an embodiment of the disclosure;

FIG. 3 shows a flowchart of an exemplary SR period extension process according to an embodiment of the disclosure; and

FIG. 4 shows an exemplary apparatus according to embodiments of the disclosure.

### DETAILED DESCRIPTION OF EMBODIMENTS

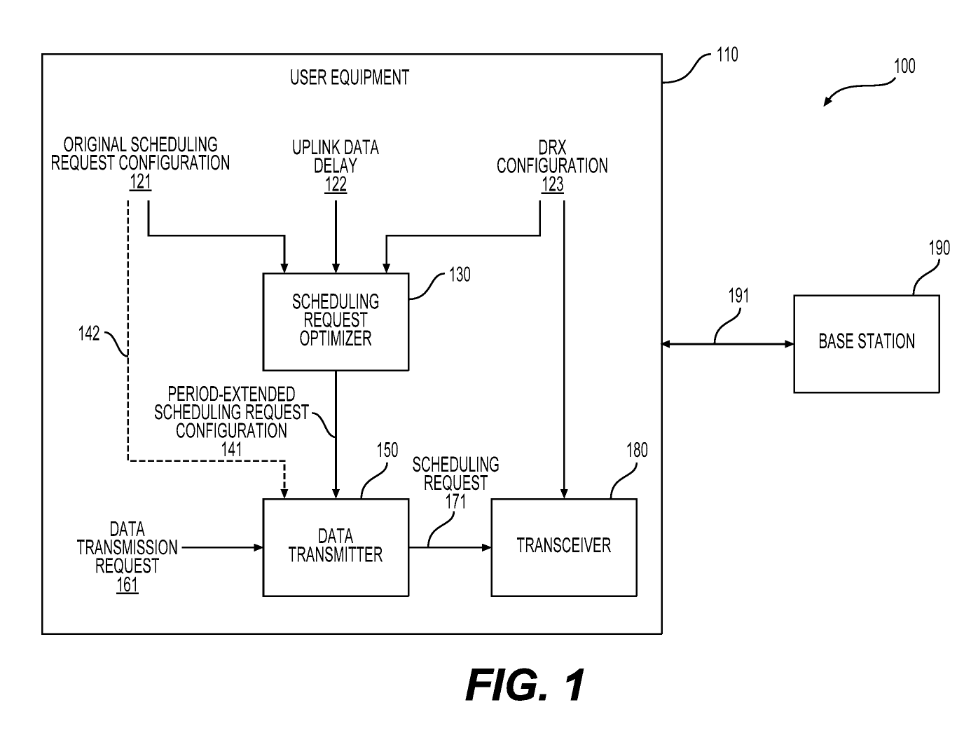

FIG. 1 shows a wireless communication network 100 according to an embodiment of the disclosure. The wireless communication network 100 can include user equipment (UE) 110 and a base station 190. The UE 110 can include a scheduling request (SR) optimizer 130, a data transmitter 150, and a transceiver 180. The wireless communication network 100 can be various wireless communication networks, such as a network compliant with 3rd Generation Partnership Project (3GPP) LTE standards, or new radio (NR) standards, or any other types of wireless communication networks that may compliant to other communication standards. Accordingly, the base station 190 can be an eNodeB base station implementing an eNodeB node specified in the 3GPP LTE standards, a base station implementing a gNB node specified in the 3GPP NR standards, or other types of base stations implementing other communication standards.

The UE 110 can communicate with the base station 190 through a wireless communication channel 191 according to communication protocols specified in respective communication standards. The UE 110 can be any device capable of wirelessly communicating with the wireless communication network 100, such as a mobile phone, a laptop computer, a vehicle carried device, and the like.

The transceiver 180 can be configured to transmit data from the UE 110 to the base station 190 or receive data from the base station 190. Particularly, the transceiver 180 can operate in a power saving mode, referred to as discontinuous reception (DRX), according to a DRX configuration 123. With DRX enabled, the transceiver 180 can periodically transition between an active state and a sleep state while communicating with the base station 190. For example, in an LTE network, when in active state, the transceiver 180 can monitor physical downlink control channel (PDCCH) to check if there is downlink data available, while in the sleep state, the transceiver 180 can power down circuitry of the transceiver to save power. Accordingly, a period corresponding to the active state is referred to as a DRX active time or on duration, while a period corresponding to the sleep state is referred to as a DRX sleep time or off duration. A cycle including an active time and a sleep time is referred to as a DRX cycle.

The DRX configuration 123 can include a set of parameters specifying lengths of the DRX active time and the DRX cycle as well as when active times or sleep times take place in a sequence of subframes. In one example, a DRX start offset can be specified to indicate positions of each DRX cycle in a sequence of subframes. For example, on duration of DRX cycles can start at a subframe satisfying the following condition:

[(SFN*10)+subframe number]modulo(DRX cycle)=DRX start offset,

where the SFN represents a system frame number (SFN) of a frame including the subframe, the subframe number can be a number in the range of 0 to 9 indicating a position of the subframe in the frame, the DRX cycle can represent a number of subframes within a DRX cycle, and the DRX start offset can be in a range from 0 to (DRX cycle−1) and represent a number of subframes.

The DRX configuration 123 can be received from the base station 190. Thus, the base station 190 knows the DRX configuration 123, and initiates downlink data transmission during DRX active times accordingly. In one example, a DRX active time can be in a range from 1 subframe to 200 subframes, while a DRX cycle can be in a range from 10 to 2560 subframes.

The data transmitter 150 can be configured to receive a data transmission request 161 and accordingly initiate an uplink data transmission. For example, one or more applications in the UE 110 may generate packets to be transmitted to the base station 190. The packets can be generated as bursts of packets with gaps between bursts. In an LTE network that employs resource scheduling mechanism, uplink transmission resources are assigned by a base station to a UE when there is data to be transmitted at the UE. When there are no packets to be transmitted during an inter-burst gap, the data transmitter 150 can be in a standby state, and accordingly there is no uplink transmission resources assigned to the UE 110. After reception of the data transmission request 161, for example, from an application, if there are no uplink resources available, the data transmitter 150 can transmit to the base station 190 an uplink scheduling request (SR) 171 for an uplink resource grant.

As an example, in an LTE network, a sequence of periodic SR transmission opportunities can be configured for transmitting SRs. For example, dedicated resources occurring every nth subframe can be assigned to the UE 110. The subframe carrying an SR resource is referred to as an SR subframe. The sequence of periodic SR transmission opportunities can be specified by an SR configuration that is determined at the base station 190. The SR configuration can be referred to as an original SR configuration 121. The original SR configuration 121 can include a set of parameters specifying an SR period and positions of each SR subframes in a sequence of subframes. Similar to a DRX configuration, an SR offset can be employed to indicate or determine positions of each SR subframe. For example, a subframe satisfying the following condition can be determined to be an SR subframe:

[(SFN*10)+subframe number]modulo(SR period)=SR offset,

where the SFN represents a system frame number of a frame including the subframe, the subframe number can be a number in the range of 0 to 9 indicating a position of the subframe in the frame, the SR period can represent a number of subframes within an SR period, and the SR offset can be in a range from 0 to (SR period−1) and represent a number of subframes.

The base station 190 can monitoring the dedicated SR resources according to the original SR configuration 121, and capture an SR request transmitted from the UE 110 when there are packets to be transmitted at the UE 110. In one example, an SR period of an original SR configuration can be in a range from 1 subframe to 80 subframes.

The transmitter 150 can select an SR subframe, and transmit the SR 171 to the transceiver 180 such that the SR 171 can be transmitted during the selected SR subframe. After the transmission of the SR request 171, the transceiver 180 can be switched to active state to monitoring, for example, the PDCCH channel, in order to detect an uplink resource grant carried in the PDCCH channel. For example, an uplink resource grant can be received at a 4th subframe since the selected SR subframe, and respective packet data can then be prepared and transmitted at an 8th subframe since the selected SR subframe.

In one example, according to the DRX configuration 123, the transceiver 180 can switch to active state after reception of an uplink resource grant for a preconfigured period of time to monitor possible additional uplink or downlink data transmissions. Accordingly, during a period from the selected SR subframe to the end of the preconfigured period of time, the transceiver 180 can be in active state that is caused by an SR transmission. An active time of the transceiver 180 corresponding to the active state caused by the SR transmission is referred to as an SR active time. In another example, an uplink resource grant may not be received at the 4th subframe. Accordingly, additional one or more SR can be transmitted in next one or more SR transmission opportunities until an uplink grant is received. Similarly, after reception of an uplink resource grant, the transceiver 180 can be in active state for a preconfigured period of time before turning into the sleep state. In this scenario, the transceiver 180 can be in active state since the first RS transmission until the end of the preconfigured period of time after reception of the uplink grant. Accordingly, the SR active time in this scenario can be longer than that in the previous example.

In a conventional SR transmission scheme, when the data transmission request 161 arrives, the data transmitter 150 would take a first available SR opportunity to transmit the SR 171 according to the original SR configuration 121 (as indicated by a dashed line 142 in FIG. 1). However, the SR active time may not overlap a DRX active time due to the respective SR configuration 121 and DRX configuration 123. Conversely, the SR active time may overlap a DRX inactive time. In such a scenario, the transceiver 180 can be caused to wake up from a sleep mode before a next regular active time. As a result, the DRX power saving mode can be interrupted causing additional power consumption.

According to an aspect of the disclosure, an SR period extension scheme can be employed to optimize SR transmission opportunities such that resultant SR active times can maximally overlap the DRX active times, and minimally overlap the DRX inactive times. Specifically, in FIG. 1 example, the SR optimizer 130 can perform an SR period extension process to generate a period-extended SR configuration 141 based on the original SR configuration 121 and the DRX configuration 123. The period-extended SR configuration 141 can then be used for SR transmissions in place of the original SR configuration 121 to reduce interruptions to the DRX power saving mode.

During the SR period extension process, an extended SR period can first be determined. The extended SR period can be a multiple of an original period specified by the original SR configuration 121. The extended SR period can define a new sequence of SR transmission opportunities, referred to as an extended SR sequence, while the sequence of SR transmission opportunities defined by the original SR configuration 121 can be referred to as an original SR sequence.

Corresponding to the determined extended SR period, the extended SR sequence can have multiple options of SR offsets, referred to as candidate SR offsets. For example, the number of the candidate SR offsets can equal a ratio of the extended SR period to the original SR period. The set of candidate SR offsets can include an original SR offset corresponding to the original SR sequence, and SR offsets that equal to the original SR offset plus one or more original SR periods. An SR offset can then be selected from the set of candidate SR offsets to be the SR offset of the extended SR sequence. For example, a candidate SR offset having a maximum overlap between SR active times and DRX active times can be determined to be the SR offset of the extended SR sequence. In this way, the period-extended SR configuration 141 can be determined.

In addition, an uplink data delay 122 that some applications in the UE 110 can tolerate can be used as an upper limit for SR period extension in some examples. An uplink data delay can be a time period since arrival of a data transmission request at the data transmitter 150 until respective packet data being transmitted with a resource grant. For example, an uplink data delay can include a first time period after arrival of a data transmission request 161 and before a transmission of an SR, a second time period since the transmission of the SR until reception of a uplink resource grant, and a third time period after reception of the uplink resource grant until a transmission of the respective data. Extending an SR period can potentially increase the time period between arrival of a data transmission request 161 and transmission of a respective SR, thus increasing the uplink data delay. On the other side, different applications can have different data delay requirements. For example, a video conference application can require data be transmitted in real time, while a website browsing application can tolerate a longer latency than a video conference application. For some background applications (such as software updating), the data delay can be even longer.

Accordingly, in one example, a minimum data delay value that all applications can tolerate can be used as the uplink data delay 122. In this way, an extended sequence of SR transmission opportunities with an extended SR period can be suitable for all applications. In alternative examples, the applications in the UE 110 can be categorized according to their uplink delay requirements, and a period-extended SR configuration can be determined for each category. Accordingly, different period-extended SR configuration can be selected by the data transmitter 150 for transmission packet data from different applications. In this way, a category of applications that can tolerate a longer uplink delay can potentially have a longer extended SR period, resulting in fewer SR transmissions and lower power consumption level.

Further, in some examples, options of the extended SR period determined during the SR period extension process can be limited to be smaller than or equal to the DRX cycle specified by the DRX configuration 123. For extended SR periods in a range beyond a DRX cycle, in some examples, when a length of an extended SR period increases, respective power savings associated with overlaps between SR and DRX active times do not increase accordingly while uplink data delay may be accordingly increased, which does not benefit performance of the UE 110. Thus, extended SR periods longer than the DRX cycle can be excluded from the options for determining the extended SR period during the SR period extension process.

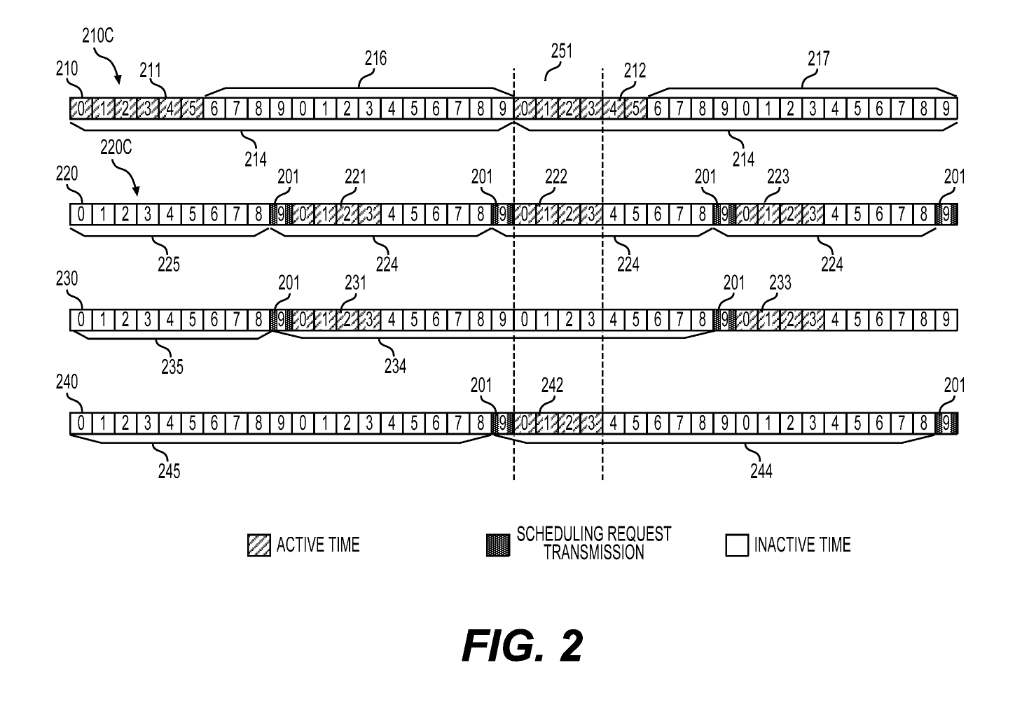

FIG. 2 shows an example of the SR period extension scheme according to an embodiment of the disclosure. Four sequences 210-240 of subframes are shown in FIG. 2. For example, the sequences 210-240 of subframes can be subframes of an LTE system each having duration of one transmission time interval (TTI), for example, 1 ms. Each 10 subframes can form a frame each having a system frame number (SFN). As shown, the first 10 subframes numbered from 0 to 9 of each sequence 210-240 can be a frame having an SFN equals 0.

A DRX configuration 210C is shown on the first sequence 210. As shown, a respective DRX defined by the DRX configuration 210C can have a DRX cycle 214 of 20 subframes, and on duration of 6 subframes. In addition, the respective DRX can have a DRX start offset of 0 subframes. Further, two DRX active times 211 and 212 each having a length of 6 subframes and two DRX inactive times 216 and 217 each having a length of 15 subframes are also shown.

An original SR configuration 220C is shown on the second sequence 220. As shown, an original SR sequence defined by the original SR configuration 220C can have an original SR period 224 of 10 subframes, and an SR offset 225 of 9 subframes. Accordingly, the 9th subframe 201 in each frame can be an SR subframe 201 carrying dedicated resources for SR transmission. Following each SR subframes 201, there can be SR active times 221-223. Duration of each SR active time 221-223 can be a predetermined value. For example, the duration of the SR active times 221-223 can be determined to be a value between 4 to 8 TTIs in one example. In one example, for purpose of determining overlaps between DRX active times and SR active times, an SR active time can be predetermined to be a time period since transmission of an SR until reception of an uplink resource grant assuming the uplink resource grant is received without transmitting a second SR. In a further example, an SR active time can be predetermined to be a time period since transmission of an SR until reception of an uplink resource grant plus a preconfigured time period corresponding to a DRX active state after reception of an uplink resource grant.

It is noted that SR transmissions at UE 110 does not take place for every SR opportunity. For example, when there is a need for uplink data transmission and no uplink resources are available, an SR would be transmitted. When no packet data is to be transmitted, no SR would be transmitted. Also, SR active times after transmissions of SRs can have different length. However, for purpose of determining an extended SR sequence, the SR active times 221-223 are assumed to take place after each SR subframe, and a predetermined duration can be assigned to the SR active times 221-223.

Based on the above assumption, when the original SR configuration 220C is used for transmission of the SR 171, during the SR active times 221 and 223, the transceiver 180 will wake up for detecting an uplink resource grant. As a result, the DRX inactive times 216 and 217 can be interrupted. In contrast, for the SR active time 222, the SR active time 222 overlaps the DRX active time 212, resulting in an overlapping period 251 lasting for 4 subframes, or 4 ms.

An SR period extension process can be carried out based on the DRX configuration 210C and the SR configuration 220C in the following way. First, an extended SR period can be determined. For example, the extended SR period can be a multiple of the original SR period (10 subframes), such as 20 subframes. Additionally, when determining the extended SR period, options of the extended SR period can be limited to be not greater than the DRX cycle 214 in FIG. 2, or the uplink data delay 122 in FIG. 1 example.

Accordingly, an extended sequence of SR transmission sequences corresponding to the above determined extended SR period, 20 subframes, can have two candidate SR offsets 235 and 245 as shown in FIG. 2. The first candidate SR offset 235, as shown on the third sequence of frames 230, can be equal to the SR offset 225 of the original SR sequence. The second candidate SR offset 245, as shown on the fourth sequence of frames 240, can equal to the SR offset 225 plus the original SR period. The two candidate SR offsets indicate two possible locations of the extended sequence of SR transmission sequences.

Second, overlaps between active times caused by DRX and SR transmissions can be calculated for each candidate SR offset 235 or 245. In various examples, an overlap between DRX active times caused by DRX and SR active times caused by SR transmissions can be measured with a number of subframes, a number of TTIs, or a number of milliseconds, and the like. As shown in FIG. 2, corresponding to the candidate SR offset 235, a candidate extended SR sequence on the frame sequence 230 includes SR active times 231 and 233 that does not overlap with any DRX active times 211 or 212 of the DRX configuration 210C. In contrast, corresponding to the candidate SR subframe 245, a candidate extended SR sequence on the frame sequence 240 includes an SR active time 242 that overlaps with the DRX active time 212 of the DRX configuration 210C.

Thus, the candidate SR subframe offset 245 has a larger overlap than the candidate SR offset 235. Accordingly, the candidate SR offset 245 can be determined to be the SR offset of the extended SR sequence corresponding to the extended SR period determine in the first step. A period-extended SR configuration can thus be determined which includes the determined extended SR period and the selected SR offset. When such period-extended SR configuration is employed for SR transmission at the data transmitter 150, there can be minimal interruptions to DRX active times of the DRX configuration 210C.

In various examples, a general way for calculating overlaps for each candidate SR offset is to perform the calculation within a time period that is a common multiple of a respective extended SR period and a respective DRX cycle. For example, a DRX cycle can be 30 subframes, while a determined extended SR period in the above first step can be 20 subframes. Therefore, a common multiple of the DRX cycle and the determined extended SR period can be 60 subframes. Accordingly, overlaps between active times caused by DRX and SR transmission for different candidate SR offsets can be performed during a period of 60 subframes.

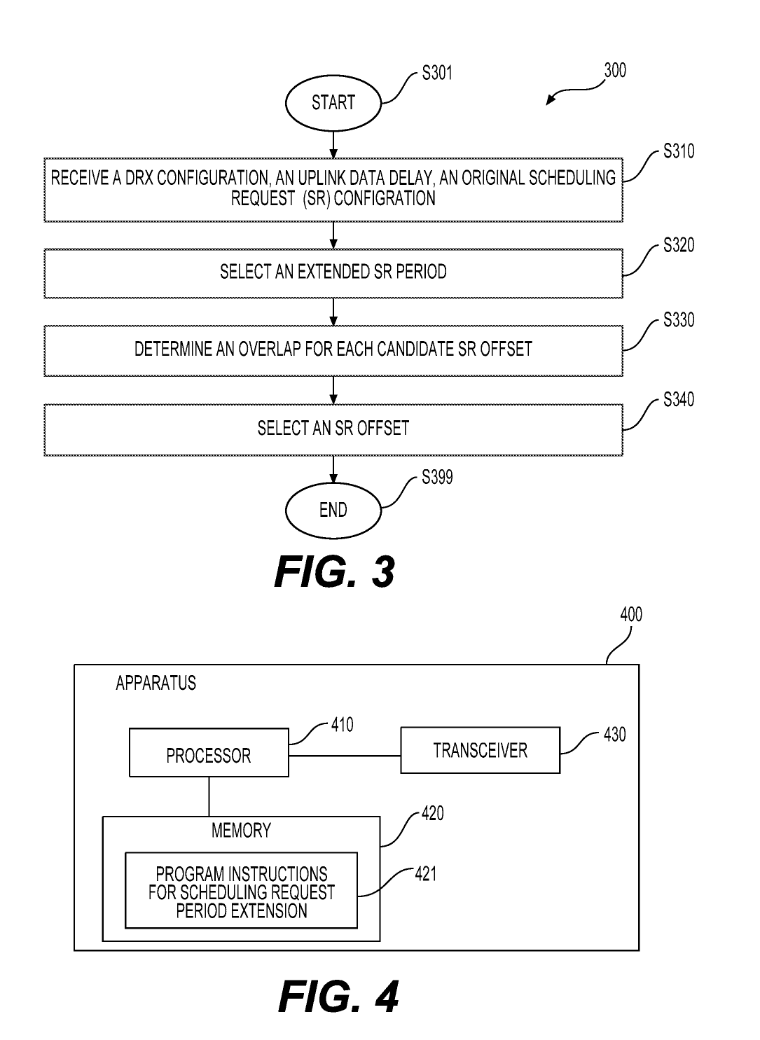

FIG. 3 shows a flowchart of an exemplary SR period extension process 300 according to an embodiment of the disclosure. The process 300 can be performed by the scheduling request optimizer 130 in FIG. 1 example. The process 300 can start from S301, and proceeds to S310.

At S310, a DRX configuration, an uplink data delay, an original SR configuration can be received at the SR optimizer 130. The DRX configuration can specify a DRX having an active time and an inactive time during a DRX cycle. The uplink data delay can be a delay an application can tolerate. The original SR configuration can specify an original sequence of transmission opportunities having an original SR period and an original SR offset.

At S320, an extended SR period can be determined based on the DRX cycle and the uplink data delay. The extended SR period can correspond to an extended sequence of SR transmission opportunities. For example, options of the extended SR period can be limited to be smaller or equal to the DRX cycle or the uplink data delay. In addition, the extended SR period can be a multiple of the original SR period. Further, the extended SR period can have a set of candidate SR offsets which can be the original SR offset, or the original SR offset plus one or more original SR period. The number of the candidate SR offsets can equal to a ratio of the extended SR period to the original SR period.

At S330, an overlap can be determined for each candidate SR offsets. The overlap can be a time period when both DRX active times caused by the DRX and SR active times caused by transmission of SRs during each of the extended sequence of transmission opportunities take place. Corresponding to different candidate SR offsets, the extended sequence of transmission opportunities can have different locations along a sequence of subframes. In addition, the overlaps can be calculated within a time period equal to a common multiple of the DRX cycle and the extended SR period.

At S340, an SR offset having a largest overlap can be selected. Accordingly, a period-extended SR configuration can be determined which can include the extended SR period selected at S320, and the SR offset selected at S340. The determined period-extended SR configuration can subsequently be used for transmission SRs by the data transmitter 150. The process 300 can proceed to S399, and terminate at S399.

FIG. 4 shows an exemplary apparatus 400 according to embodiments of the disclosure. The apparatus 400 can be configured to perform various functions in accordance with one or more embodiments or examples described herein. Thus, the apparatus 400 can provide means for implementation of techniques, processes, functions, components, systems described herein. For example, the apparatus 400 can be used to implement functions of the SR optimizer 130, the data transmitter 150, and the transceiver 180. For example, the apparatus 400 can be used to implement the process 300. The apparatus 400 can be a general purpose computer in some embodiments, and can be a device including specially designed circuits to implement various functions, components, or processes described herein in some other embodiments.

The apparatus 400 can include a processor 410, a memory 420, and a transceiver 430. In a first example, the processor 410 can include circuitry configured to perform the functions of SR period extension described herein in combination with software or without software. For example, the processor 410 can include circuits configured to perform functions of the SR optimizer 130 and the data transmitter 140, and to perform all or a portion of the steps of the process 400. In various examples, the processor 410 can be a digital signal processor (DSP), an application specific integrated circuit (ASIC), programmable logic devices (PLDs), field programmable gate arrays (FPGAs), digitally enhanced circuits, or comparable device or a combination thereof. Although illustrated as a single processor, it will be appreciated that the processor 410 can compromise a plurality of processors.

In a second example, the processor 410 can be a central processing unit (CPU) configured to execute program instructions to perform various functions and processes described herein. Accordingly, the memory 420 can be configured to store program instructions 421 for SR period extension. In one example, the processor 410, when executing the program instructions 421 for SR period extension, can perform the functions of the components in the UE 110, or perform the steps of the processes 300. The memory 420 can further store other programs or data, such as operating systems, application programs, and the like. The memory 420 can include a read only memory (ROM), a random access memory (RAM), a flash memory, a solid state memory, a hard disk drive, an optical disk drive, and the like.

The transceiver 430 can enable the apparatus 400 to transmit wireless signals to and receive wireless signals from one or more base stations, such as the base station 190, in one or more wireless networks. The transceiver 430 can be configured to support any types of radio access technologies that may be implemented by the base station 190.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, such as the apparatus 400, including obtaining the computer program through physical medium or distributed system, including, for example, from a server connected to the Internet.

The computer program may be accessible from a computer-readable medium providing program instructions for use by or in connection with a computer or any instruction execution system. A computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium and solid state storage medium.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate, preclude or suggest that a combination of these measures cannot be used to advantage.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method for reducing power consumption of a wireless communication device, comprising:
receiving a discontinuous reception (DRX) configuration specifying a DRX having a DRX cycle;
receiving an original scheduling request (SR) configuration specifying an original sequence of SR transmission opportunities having an original SR period;
selecting an extended SR period corresponding to an extended sequence of SR transmission opportunities according to the DRX cycle, the extended SR period being a multiple of the original SR period and corresponding to a set of candidate SR offsets;
determining for each of the set of candidate SR offsets an overlap between active times caused by the DRX and active times caused by SR transmissions at each of the extended sequence of SR transmission opportunities; and
selecting one of the SR offsets having a largest overlap from the set of the candidate SR offsets to determine a period-extended SR configuration including the selected extended SR period and the selected SR offset.

2. The method of claim 1, wherein the set of candidate SR offsets includes an original SR offset specified by the original SR configuration, and one or more SR offsets equal to the original SR offset plus one or more original SR periods.

3. The method of claim 1, wherein the extended SR period is equal to or smaller than the DRX cycle of the DRX.

4. The method of claim 1, wherein the extended SR period is smaller than an uplink data transmission delay that an application in the wireless communication device can tolerant.

5. The method of claim 1, wherein the overlap between the active times caused by the DRX and the active times caused by SR transmissions is calculated within a time period equal to a common multiple of the DRX cycle of the DRX and the selected extended SR period.

6. The method of claim 1, further comprising:
determining a period-extended SR configuration for each of multiple categories of applications in the wireless communication device.

7. The method of claim 6, further comprising:
transmitting an SR for an application according to a period-extended SR configuration corresponding to a category of applications including the application.

8. A wireless communication device, comprising circuitry configured to:
receive a discontinuous reception (DRX) configuration specifying a DRX having a DRX cycle;
receive an original scheduling request (SR) configuration specifying an original sequence of SR transmission opportunities having an original SR period;
select an extended SR period corresponding to an extended sequence of SR transmission opportunities according to the DRX cycle, the extended SR period being a multiple of the original SR period and corresponding to a set of candidate SR offsets;
determine for each of the set of candidate SR offsets an overlap between active times caused by the DRX and active times caused by SR transmissions at each of the extended sequence of SR transmission opportunities; and
select one of the SR offsets having a largest overlap from the set of the candidate SR offsets to determine a period-extended SR configuration including the selected extended SR period and the selected SR offset.

9. The wireless communication device of claim 8, wherein set of candidate SR offsets includes an original SR offset specified by the original SR configuration, and one or more SR offsets equal to the original SR offset plus one or more original SR periods.

10. The wireless communication device of claim 8, wherein the extended SR period is equal to or smaller than the DRX cycle of the DRX.

11. The wireless communication device of claim 8, wherein the extended SR period is smaller than an uplink data transmission delay that an application in the wireless communication device can tolerant.

12. The wireless communication device of claim 8, wherein the overlap between the active times caused by the DRX and the active times caused by SR transmissions is calculated within a time period equal to a common multiple of the DRX cycle of the DRX and the selected extended SR period.

13. The wireless communication device of claim 8, wherein the circuitry is further configured to:
determine a period-extended SR configuration for each of multiple categories of applications in the wireless communication device.

14. The wireless communication device of claim 13, wherein the circuitry is further configured to:
transmit an SR for an application according to a period-extended SR configuration corresponding to a category of applications including the application.

15. A non-transitory computer readable medium storing program instructions that, when executed by a processor, cause the processor to perform a method for reducing power consumption of a wireless communication device, the method comprising:
receiving a discontinuous reception (DRX) configuration specifying a DRX having a DRX cycle;
receiving an original scheduling request (SR) configuration specifying an original sequence of SR transmission opportunities having an original SR period;
selecting an extended SR period corresponding to an extended sequence of SR transmission opportunities according to the DRX cycle, the extended SR period being a multiple of the original SR period and corresponding to a set of candidate SR offsets;
determining for each of the set of candidate SR offsets an overlap between active times caused by the DRX and active times caused by SR transmissions at each of the extended sequence of SR transmission opportunities; and
selecting one of the SR offsets having a largest overlap from the set of the candidate SR offsets to determine a period-extended SR configuration including the selected extended SR period and the selected SR offset.

16. The non-transitory computer readable medium of claim 15, wherein the set of candidate SR offsets includes an original SR offset specified by the original SR configuration, and one or more SR offsets equal to the original SR offset plus one or more original SR periods.

17. The non-transitory computer readable medium of claim 15, wherein the extended SR period is equal to or smaller than the DRX cycle of the DRX.

18. The non-transitory computer readable medium of claim 15, wherein the extended SR period is smaller than an uplink data transmission delay that an application in the wireless communication device can tolerant.

19. The non-transitory computer readable medium of claim 15, wherein the overlap between the active times caused by the DRX and the active times caused by SR transmissions is calculated within a time period equal to a common multiple of the DRX cycle of the DRX and the selected extended SR period.

20. The non-transitory computer readable medium of claim 15, wherein the method further comprising:
determining a period-extended SR configuration for each of multiple categories of applications in the wireless communication device.
